(19) United States
(12) Patent Application Publication
(10) Pub. No.: US 2025/0273866 A1
(43) Pub. Date: Aug. 28, 2025

(54) Antenna Arrangement Comprising a Plurality of Integrated Antennas

(71) Applicant: Shortlink Resources AB, Karlstad (SE)

(72) Inventor: Alf FRIMAN, Växjö (SE)

(21) Appl. No.: 18/857,887

(22) PCT Filed: Oct. 26, 2023
(86) PCT No.: PCT/EP2023/060119

§ 371 Date: Oct. 18, 2024

(30) Foreign Application Priority Data
Apr. 19, 2022 (SE) 2250474-0

(51) Int. Cl. H01Q 9/42; H01Q 1/22; H01Q 1/24; H01Q 1/52; H01Q 5/35; H01Q 21/28

(52) U.S. Cl. CPC H01Q 9/42; H01Q 1/2283; H01Q 1/521; H01Q 5/35; H01Q 21/28; H01Q 1/2291; H01Q 1/243

(57) ABSTRACT

An antenna arrangement comprises a dielectric substrate with a first surface and second surface extending between a first edge and second edge of the substrate. A conductive pattern is arranged on the first surface that forms first, second, and third antenna elements. The first antenna element is arranged in the vicinity of the first edge and connected to a first antenna feed. The second antenna element is arranged in the vicinity of the second edge and connected to a second antenna feed. The third antenna element is arranged between the first and second antenna elements and connected to a third antenna feed. An intermediate element, at least partly functioning as a ground layer, is arranged between the first, second and third antenna elements. A non-conductive zone separates the first antenna element and the intermediate element. The second antenna element and the intermediate element are in conductive contact with each other.

### TECHNICAL FIELD OF THE INVENTION

The present invention relates to an antenna arrangement comprising a plurality of antenna elements, forming several integrated antennas.

### BACKGROUND OF THE INVENTION

There is a large and growing need of omnidirectional, broadband/wideband antennas. An increasing number of appliances and devices are now connected to the wireless network, and with the trend towards the “Internet of Things (IoT) everyday items such as household appliances, clothes, accessories, machines, vehicles and buildings are now more frequently equipped with wireless connections. This enables the devices to receive commands from users and other entities, in order to be able to be controlled remotely, to forward information from sensors and the like, etc. To provide good antennas for this type of use is still a major problem. When applied to devices, such as household appliances, antennas are often placed in bad positions, seen from the point of view of radiation and communication. Where the antennas with which the device will communicate are positioned is usually not foreseeable by the manufacturer. Moreover, there is a need to use the same or similar products on many different markets, which poses problems when communicating because different frequency bands are used in different parts of the world, etc.

Specifically, there is often a need to communicate both using conventional cellular communication, e.g. in accordance with communication standards such as 3G, 4G, 5G and/or LTE, and by WiFi, e.g. in accordance with the IEEE 802.11 standards. There may also be a need to receive position data through a global navigation satellite system (GNSS), such as the global positioning system (GPS) or the global navigation satellite system (GLONASS).

Providing separate antennas for such various purposes makes the product complex and costly. However, provision of a single antenna capable of efficient communication for all these needs is difficult to achieve.

The cellular communication, e.g. by 2G, 3G and 4G, for voice and data communication, normally occurs in frequency bands such as 700-960 MHz, 1680-2200 MHz, and 2600-2800 MHz.

Communication with GNSS satellites, such as GPS, Galileo, GLONASS and BeiDou usually occurs in frequencies such as 1550 to 1600 MHz.

Bluetooth and WiFi communication normally occurs in frequencies within the frequency band 2400-2480 MHz. In later WiFi standards, higher frequencies, such as 5 GHz, may also be used.

Ideally, an antenna arrangement should be provided able to communicate through all these systems and standards. In particular, such an antenna arrangement would be or great use for connected devices, such as in IoT, Internet of Things.

IoT is the concept of more or less smart electronic devices connected to mobile or stationary devices or equipment, and e.g. arranged to supervise, monitor, and communicate with the devices/equipment, and which may be able to control the devices/equipment.

IoT units are commonly designed as complete radio modules for each radio system. Thus, conventionally, radio units for each frequency band and each radio system needed are acquired and arranged together on the device/equipment to be provided with IoT functionality.

However, when such antennas are placed close to each other, the antennas will negatively affect each other, which will negatively affect the performance, leading to impaired radio system performance, such as lower range, higher power consumption, etc. The power consumption is a great concern, since the units are often powered by batteries, and power is a scarce resource, due to the desire to make the units small and with low weight. The batteries are often a significant part of the overall volume and weight of the units.

Another problem for IoT devices/equipment is that there is often no natural ground plane for the antennas to use efficiently, or that the ground planes available are too small for efficient use.

There is therefore a need for antenna arrangements capable of use at multiple frequencies and/or multiple radio system types, and which have overall better performance, lower power consumption, lower weight and/or smaller volume. There is further a need for a versatile antenna arrangement, which can be used on a multitude of different devices and equipment.

### SUMMARY OF THE INVENTION

It is thus an object of the present invention to provide an antenna arrangement that at least partially eliminate the above discussed problems of the known technology. This purpose is achieved with an antenna arrangement in accordance with the appended claims.

In accordance with an aspect of the invention there is provided an antenna arrangement comprising:
a dielectric substrate with a first surface and second surface extending between a first edge and second edge of the substrate;
a conductive pattern arranged on the first surface of said substrate, the pattern forming:
a first antenna element arranged in the vicinity of the first edge, connected to a first antenna feed;
a second antenna element arranged in the vicinity of the second edge, connected to a second antenna feed;
a third antenna element arranged between the first and second antenna elements, connected to a third antenna feed;
an intermediate element, at least partly functioning as a ground layer, arranged between said first, second and third antenna elements; and
a non-conductive zone separating the first antenna element and the intermediate element;
wherein the second antenna element and the intermediate element are in conductive contact with each other.

The antenna arrangement of the present invention provides three antennas, useable for different frequencies and/or radio system types. The antennas are arranged together, in a compact and cost-efficient design. The intermediate element functions both as a ground layer for the antennas, and also forms part of the radiating area of the antennas. The intermediate element thereby forms a common part of all antennas, thereby making the antenna arrangement more efficient and compact.

It has been found that in this way, very good performance and efficiency can be obtained for all the three integrated antennas.

The separation of the antenna elements on the substrate reduces coupling effects between the three antennas, and thereby minimizes the influence they have on each other. The intermediate element primarily serves as a ground plane. The ground plane is common for all the three antennas formed by the three antenna elements, which makes the antenna arrangement small and compact. At the same time, the positioning of the antenna elements in relation to the ground plane reduces coupling and influence between the antennas, which is otherwise a common problem encountered when several antennas share a common ground plane. The antennas essentially functions as monopole antennas.

The antenna arrangement can be made relatively small and compact, and at the same time provide good functionality and performance for three different types of radio systems.

In particular, the antenna arrangement provides a very good communication range, low Voltage Standing Wave Ratio (VSWR) and low power consumption. This enables the use of smaller and lighter batteries, and enhances the reliability of the antenna arrangement.

Hereby, the antenna arrangement becomes very versatile, and can easily be used and integrated in a variety of devices, such as in IoT units. The antenna arrangement could hereby be offered as an off the shelf product, useable for a great variety of different needs and applications.

The antenna arrangement of the present invention uniquely combines and integrates three different antennas, useable for, and dedicated to, three different types of communication and radio systems, and still ensures very good functionality and performance for all the three antennas.

The antenna elements may be arranged for communication through different radio system types. For example, one of the antenna elements may be arranged for communication through a cellular communication network, such as in accordance with 2G, 3G, 4G, 5G and/or LTE. Further, one of the antenna elements may be arranged for communication through WiFi, i.e. in accordance with an IEEE 802.11 standard, or Bluetooth. Still further, an antenna element may be arranged to communicate with a GNSS system.

Hereby, the combination of antennas provided by the first, second and third antenna elements covers all frequencies normally needed for communication for most devices, and in particular for most IoT units.

In an embodiment, the first antenna element may be arranged for radio communication over at least one of a 2G, 3G, 4G, 5G and LTE standard. Preferably, the first antenna element may be arranged for radio communication over at least one of 2G, 3G and 4G. To this end, the first antenna element, and the thereby formed first antenna, may be adapted to have a good performance and functionality in the frequency ranges 700-960 MHz, 1680-2200 MHz and 2600-2800 MHz.

In an embodiment, the second antenna element may be arranged for GNSS radio communication. The GNSS system may e.g. be GPS, Galileo, GLONASS and/or BeiDou. To this end, the second antenna element, and the thereby formed second antenna, may be adapted to have a good performance and functionality in the frequency range 1550-1600 MHz.

In an embodiment, the third antenna element may be arranged for communication over at least one of an IEEE 802.11 and Bluetooth standard. To this end, the third antenna element, and the thereby formed third antenna, may be adapted to have a good performance and functionality in the frequency range 2400-2480 MHz. However, the third antenna element and third antenna may also be adapted to have a good performance and functionality in higher frequency ranges, such as at around 5 GHz.

The third antenna element is preferably arranged closer to the second antenna element than to the first antenna element. This provides enhanced separation and enhanced performance to the first antenna element.

In accordance with an embodiment, both the second and third antenna elements are positioned on one side of a center axis of the substrate and the first surface, i.e. on a first half thereof, whereas the first antenna element is arranged on an opposite side of the center axis, i.e. on the second half. A relatively long distance between the first antenna and the other antennas provides a relatively large ground plane for the first antenna, which is of particular advantage e.g. when the first antenna is used for LTE or 4G communication.

The first antenna element preferably comprises a first feed line extending between the first antenna feed and a bifurcation and two first antenna arms extending from said bifurcation in at least partly different directions. In one embodiment, the first antenna arms extends generally in an L-shape. Additionally, or alternatively, one of the first antenna arms may extend generally in a curled shape.

The first feed line may e.g. be directed generally in a length direction of the substrate, and in a direction away from the second and third antenna elements and towards the first edge.

In one embodiment, the first antenna arms each comprises a first part connected to the firs feed line, and extending in two essentially opposite directions. The first parts may extend generally in a width direction of the substrate.

The first antenna arms may further each comprise a second part, connected to the first part at a distance from the first feed line. The second parts may be extend generally in a direction away from the feed. The second parts may extend generally in the length direction of the substrate, and preferably be positioned along the long sides of the substrate.

One of the second parts may further comprise a third part, extending from the end of the second part not connected to the first part, and preferably extending generally in the width direction of the substrate. The third part may extend generally along the first edge or short side of the substrate. The third part preferably extends towards the other second part.

The third part may, at the end not connected to the second part, be connected to a fourth part. The fourth part may extend generally in the length direction of the substrate, and in a direction towards the feed, and towards the first parts. The fourth part may e.g. be essentially parallel to the second parts.

A non-conductive area may be provided between arms and arm parts. In this way, one of the arms of the bifurcation may comprise first and second parts arranged generally in an L-shape, and directed away from the feed. The other arm may have first and second parts arranged generally in an L-shape, and in addition a third part directed towards the other arm, and a fourth part directed towards the feed, to form a curled shape.

The arms preferably have a width which is at all places greater than the width of the first feed line. In an embodiment, at least one of the arms has a terminating, final part having a width which is greater than the width of the other parts of the arm. Thus, in an arm having an L-shape, the second part may have a greater width than the first part. In an arm having a curled shape, the fourth part may have a greater width than the other arm parts.

The two arms connected to the first feed line, at the bifurcation, may together form the shape of a fork, with arm parts extending along the long sides of the substrate, and with the interior of the fork optionally being partly filled with the inwardly curved terminating part of one of the arms.

The third antenna element preferably comprises a third feed line extending between the third antenna feed and a connection position and a generally T-shaped part, wherein a free end of a shaft of the T-shaped part is connected to said third feed line, and wherein the other end of the shaft is connected to an overlying beam, the beam having two arms connected to the shaft and extending in essentially opposite directions. One arm of the beam is preferably connected to the intermediate element, whereas the other arm forms a free end. Additionally, or alternatively, the beam may be displaced in relation to the shaft, with one beam arm extending farther from the shaft than the other beam arm.

The third antenna element may be arranged at an intermediate position along the length of the substrate, between the first and second antenna elements, and preferably closed to the second antenna element than to the first antenna element.

The third feed line may be directed generally in a width direction of the substrate. However, alternatively, the third feed line may have a slanted disposition, and be directed both in a width and length direction of the substrate. The third feed line may e.g. be directed generally in a width direction, towards a long side of the substrate, but be inclined towards the second antenna element and the second edge, i.e. in a direction away from the first antenna element and the first edge, when seen from the third feed.

The T-shaped part of the third antenna may have a greater width than the feed line.

The free end of the T-shaped part, forming the bottom of the T, may be connected to the third feed line. The shaft of the Tis preferably much shorter than the length of the beam. In one embodiment, the beam has a length of at least 2 times the length of the shaft, and preferably at least 3 times, and most preferably about 4 times the length of the shaft.

In one embodiment, the shaft is directed generally in the width direction of the substrate. In one embodiment, the beam is directed generally in the length direction of the substrate.

In one embodiment, one arm of the beam is connected to the intermediate element. Preferably, the arm connected to the intermediate element is the one directed towards the second antenna element, and away from the first antenna element, as seen from the shaft.

In one embodiment, at least one of the two arms forms a free end. Preferably, at least the arm directed towards the first antenna element forms a free end. The free end is preferably surrounded by a non-conductive area.

In one embodiment, the beam is displaced in relation to the shaft, with one beam arm extending farther from the shaft than the other beam arm. For example, the arm directed towards the first antenna element may be longer than the arm directed towards the second antenna element. The arm with the longer extension may e.g. be at least 2, and preferably at least 3, and more preferably at least 5 times longer than the shorter arm. Preferably, the arm forming a free end is longer than the arm forming a connection to the intermediate element.

The second antenna element preferably comprises a second feed line extending between the second feed and a connection position, connecting the feed line to an end part, wherein the junction between the second feed line and the end part forms an angle, and preferably an essentially right angle. The angle provides a phase shift, and thereby further separates the second antenna from the other antennas. This is particularly useful when the second antenna is arranged to receive relatively weak GNSS signals.

Preferably, the end part is generally U-shaped, with one of the ends being connected to the second feed line. Additionally, or alternatively, the second antenna element may be connected to the intermediate element at said junction between said second feed line and said end part.

In one embodiment, the second feed line extends essentially in the length direction of the substrate. Preferably, the second feed line extends in a direction, seen from the second feed, which is directed away from the first antenna element. Preferably, the second feed line, extends in a direction which is opposite to the direction of the first feed line, as seen from the second and first feeds, respectively.

The junction between the second feed line and the end part preferably forms an angle, and preferably an essentially right angle. In the vicinity of the junction, and preferably at a corner formed at the junction, the second antenna element may also form a connection to the intermediate element.

Preferably, the end part is generally U-shaped, with one of the ends, i.e. one of the upper free ends of the U, being connected to the second feed line.

In an embodiment, the end part comprises a first arm section, connected to the second feed line, and preferably extending in a width direction of the substrate. The end part may further comprise a second arm section, forming an angle in relation to the first arm section, and preferably essentially a right angle. The second arm section preferably extends along the length direction of the substrate, and preferably in a direction away from the first antenna element, as seen from the first arm section, i.e. towards the second edge. The end part may further comprise a third arm section, connected to the second arm section and forming an angle in relation to this, and preferably essentially a right angle. The third arm section preferably extends essentially in the width direction of the substrate, and preferably essentially in parallel with the first arm section. The third arm section may extend along the second edge of the substrate. The third arm section preferably forms a free end, not conductively connected to the intermediate element.

The total area of the intermediate layer is preferably significantly greater than the total area of the antenna elements. In one embodiment, the total area of the intermediate element is at least 2 times the total area of the antenna elements, and preferably at least 3 times, and more preferably at least 5 times the total area of the antenna elements.

The substrate is preferably elongate, with the longest direction, the length direction, between the first and second edges. In one embodiment, the substrate is rectangular, with two short sides, forming the first and second edges, and two long sides extending between the first and second edges.

The length of the substrate may be in the range of 7-15 cm, and preferably 8-12 cm, such as about 10 cm. The width of the substrate may be in the range of 3-6 cm, and preferably 3.5-5 cm, such as about 4 cm.

In an embodiment, the first, second and third antenna feeds are all arranged on a common straight line. This makes it easier to connect the antenna arrangement, e.g. for assembly of the antenna arrangement in an IoT unit. The feeds are also preferably all arranged at a certain distance from the first and second edges, and also preferably from the long sides. This allows cables connected to the feeds to be drawn in such a way that they do not overlap the most active parts of the antennas.

One or more of the antennas formed by the three antenna elements may further have a matching network or matching components for controlling the impedance to the antennas. To this end, the antenna arrangement may comprise predefined positions, preferably with solder connection areas, for connecting components having an impedance in the vicinity of the feeds and feed connectors. The components may e.g. be resistors, capacitors and/or inductors. Such components may e.g. be used to provide a matched impedance of about 50 Ohm. The connection areas enable surface mounting of the components, and consequently makes it easy to control the impedance for any particular use of the antenna arrangement. Such components are per se commercially available, and may e.g. have a size of about 1×0.5 mm.

In one embodiment, connection areas are provided for connection of three impedance controlling components in the vicinity of a feed connector, and preferably for all the feed connectors.

### BRIEF DESCRIPTION OF THE DRAWINGS

The present invention will be described in more detail with reference to the appended drawings, showing currently preferred embodiments of the invention.

FIG. 1 is a schematic cross-sectional view, illustrating stacked layers of an antenna arrangement in accordance with an embodiment.

FIG. 2a is a top view from above of an upper side of antenna arrangement in accordance with an embodiment, and FIG. 2b is a top view of the same antenna arrangement with feed cables being attached to the feed connectors;

FIG. 3 is a side view of the antenna arrangement with connected feed cables of FIG. 2b;

FIG. 4 is a top view of a first side of the substrate of the antenna arrangement of FIGS. 2-3;

FIG. 5 is a top view of a second side of the substrate of FIG. 4;

FIG. 6a is showing an enlarged part of the structure illustrated in FIG. 4, including the first antenna element, and FIG. 6b shows an enlarged part of the side illustrated in FIG. 2a, including the feeding arrangement for the first antenna element; and

FIG. 7a is showing an enlarged part of the structure illustrated in FIG. 4, including the second and third antenna elements, and FIG. 7b shows an enlarged part of the side illustrated in FIG. 2a, including the feeding arrangement for the second and third antenna elements.

### DETAILED DESCRIPTION OF CURRENTLY PREFERRED EMBODIMENTS

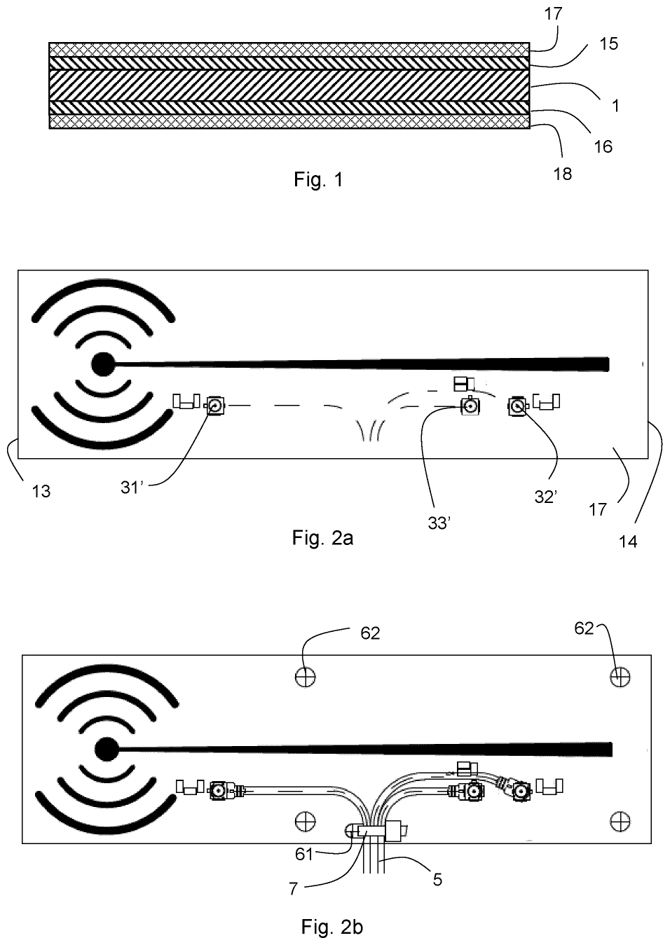

Embodiments of an antenna arrangement will now be discussed in more detail, with reference to FIGS. 1-7.

The antenna arrangement may be formed as a laminated, stacked PCB, as is schematically illustrated in FIG. 1. The antenna arrangement may comprise an inner substrate 1, having a first surface 11, here turned upwards, and a second surface 12, here turned downwards. A conductive material, such as copper, may be arranged on one or both the substrate surfaces, and may be formed into a desired pattern, e.g. by etching, as is per se known in the art. In the exemplary embodiment, a first conductive layer 15 is provided on the first side 11 of the substrate, i.e. on the upper side, and a second conductive layer 16 is provided on the second surface 12 of the substrate, i.e. on the bottom side. A top layer 17 may be provided above the first conductive layer 13, and another top layer 18 may be arranged below the second conductive layer 14. The substrate 1 is preferably be made of a dielectric material. The top layers 15, 16 may also be made of dielectric material.

Even though reference is here and, in the following, sometimes made to “upper”, “lower”, “top” and “bottom”, it to be appreciated that these words are only used to distinguish the parts from each other, and do not by necessity reflect any actual relative placement and positioning of the parts.

FIG. 2 illustrates the upper side of an antenna arrangement, and a top layer 17 thereof. On this side, the antenna arrangement comprises feed connectors, for connecting feed cables to the antennas. More specifically, there is provided a first feed connector 31′, e.g. for use in 3G or 4G communication, a second feed connector 32′, e.g. for use in WiFi and Bluetooth communication, and a third feed connector 33′, e.g. for use in GNSS communication.

The substrate is preferably elongate, with the longest direction, the length direction, between a first edge 13 and a second edge 14. Preferably, the substrate is rectangular, with two short sides, forming the first and second edges 13, 14, and two long sides extending between the first and second edges.

The length of the substrate may be in the range of 7-15 cm, and preferably 8-12 cm, such as about 10 cm. The width of the substrate may be in the range of 3-6 cm, and preferably 3.5-5 cm, such as about 4 cm. The thickness of the antenna arrangement may be a few mm.

The first, second and third antenna feed connectors 31′-33′ are all arranged on a common straight line.

Further connection pads or connection areas for attachment of impedance matching components may also be arranged on the top surface 17, as will be discussed in more detail in the following.

FIG. 2b illustrates the same antenna arrangement as in FIG. 2a, but with feed cables 5 being connected to the feed connectors 31′-33′. The cables may e.g. be coaxial cables, but other cable types may also be used.

The antenna arrangement may be provided with throughgoing openings 61, allowing the cables to be fixated by a strap 7 or the like.

Other throughgoing openings 62 may also be provided, for fixation of the antenna arrangement to an external item, such as an IoT connected device/equipment. Such fixation may be obtained by straps, bolts, screws, and the like, as is per se well known in the art.

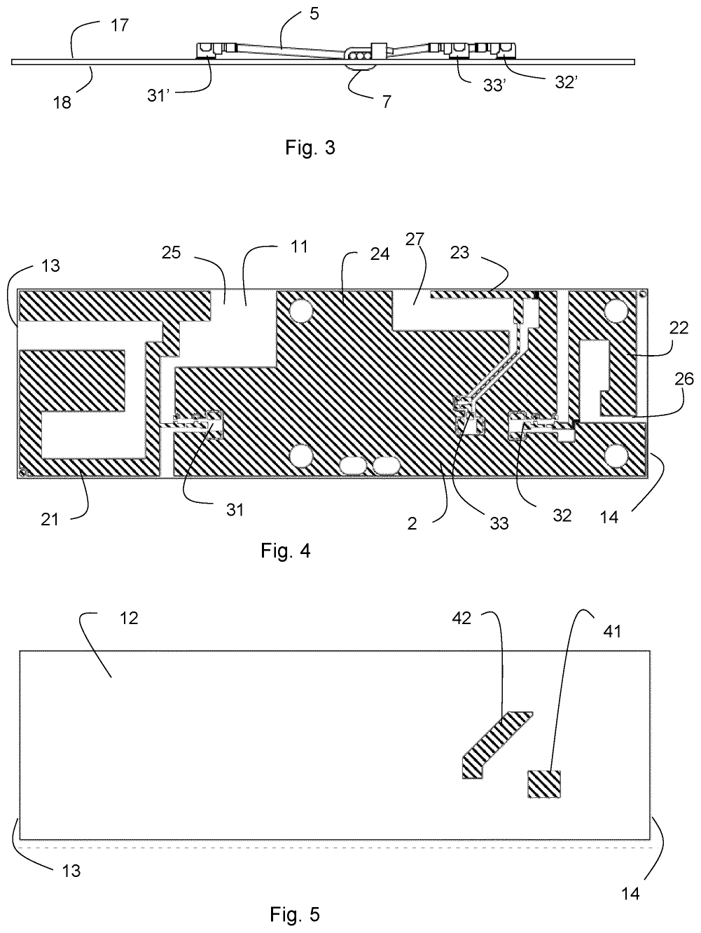

FIG. 3 is a sideview illustrating the antenna arrangement of FIG. 2b, with the cables attached to the feed connectors.

The conductive pattern 2 formed in the conductive layer 15 arranged beneath the top layer 17 will now be discussed in more detail, with reference to FIG. 4. As will be explained, the conductive pattern forms the three antennas of the antenna arrangement.

With reference to FIG. 4, the conductive pattern 2 arranged on the first surface 11 of the substrate 1 comprises a first antenna feed 31, connected to the first feed connector 31′, a second antenna feed 32, connected to the second feed connector 32′ and a third antenna feed 33, connected to the third feed connector 33′.

The first antenna feed 31 is connected to a first antenna element 21, the second antenna feed 32 is connected to a second antenna element 22 and the third antenna feed 33 is connected to a third antenna element 23.

The first antenna element 21 is here arranged in the vicinity of the first edge 13, the second antenna element 22 is arranged in the vicinity of the second edge 14. Thus, the first and second antenna elements 21 and 22 are arranged at opposite ends of the substrate. The third antenna element 23 is arranged between the first and second antenna elements 21, 22.

The third antenna element 23 is preferably arranged closer to the second antenna element 22 than to the first antenna element 21. In the illustrative example, the second and third antenna elements 22, 23 are both positioned on one side of a center axis of the substrate and the first surface 11, i.e. on a first half thereof, whereas the first antenna element 21 is arranged on an opposite side of the center axis, i.e. on the second half.

Between the antenna elements, and acting as a ground plane, an intermediate element 24 is provided. The intermediate element 24 may at some points be in conductive contact with one or more of the antenna elements, and in particular the second and third antenna elements 22 and 23, as will be discussed in more detail in the following. However, apart from these few contact points, the antenna elements are separated from the intermediate element 24 through one or more non-conductive zones. Specifically, a non-conductive zone 25 may be provided, separating the first antenna element 21 from the intermediate element 24. Further, a second non-conductive zone 26 may be provided, separating at least most of the second antenna element 22 from the intermediate element 24. Still further, a third non-conductive zone 26 may be provided, separating at least most of the third antenna element 23 from the intermediate element 24.

On the second side 12 of the substrate 1, a second conductive pattern may be provide in the conductive layer 16. This layer may e.g. form areas where an capacitive coupling between parts in the conductive pattern on the first side 11 is needed or wanted. In the illustrative example, as illustrated in FIG. 5, there is provided two conductive areas. A first conductive area 41 is arranged underlying a connection between the second antenna element 22 and the intermediate layer 24, which will be discussed in more detail in the following. The conductive area 41 may e.g. be formed as a rectangle. A second conductive area 42 may be arranged underlying the third feed 33, and also a feed line connecting the third feed to the rest of the third antenna element 23. The second conductive area 42 may have a shape generally corresponding to the shape of the third feed 33 and the feed line.

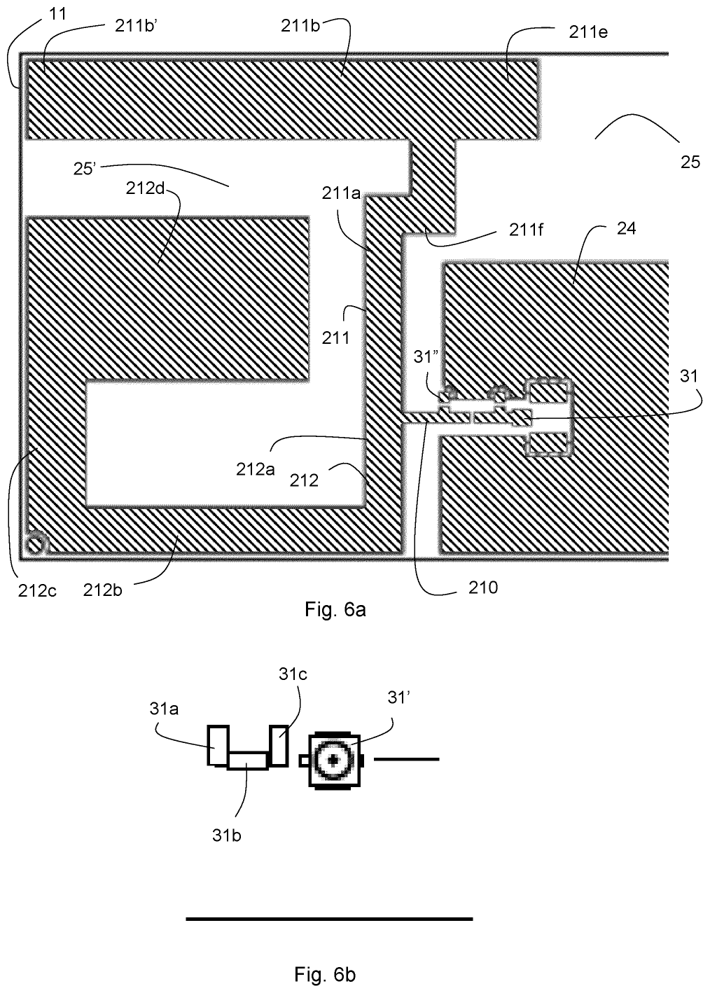

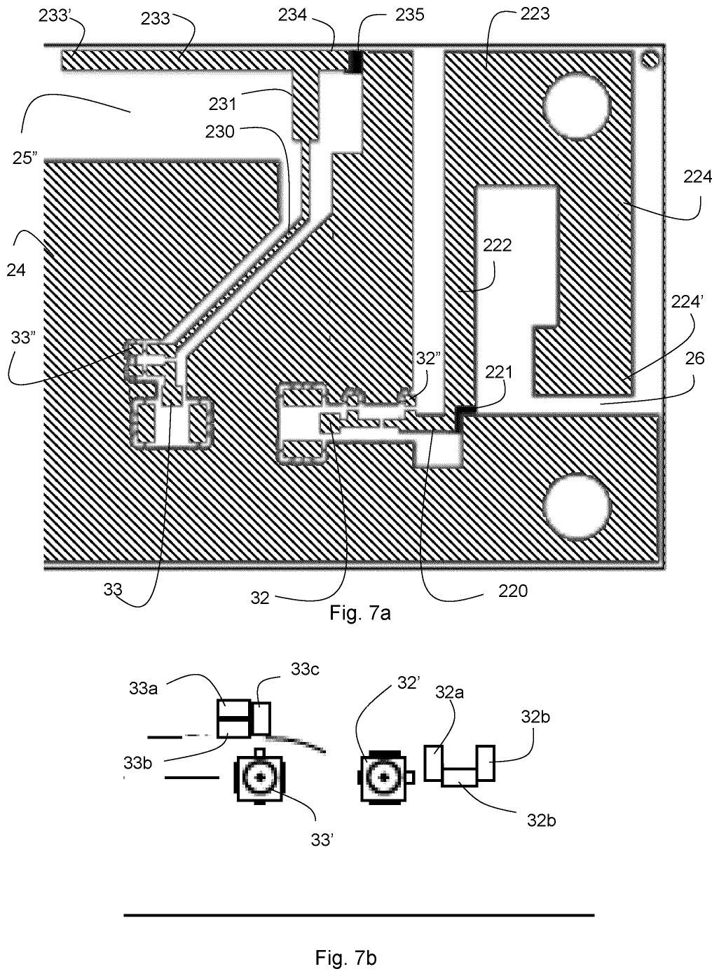

The antenna elements will now be discussed in more detail with reference to FIGS. 6a, 6b, 7a and 7b.

The first antenna element is illustrated in detail in FIG. 6a. The first antenna element here comprises a first feed line 210 extending between the first antenna feed 31 and a bifurcation, and two first antenna arms 211, 212 extending from said bifurcation in at least partly different directions. In the illustrative embodiment, the first antenna arms 211, 212 extend generally in an L-shape. Additionally, or alternatively, one of the first antenna arms may extend generally in a curled shape.

The first feed line 210 may e.g. be directed generally in a length direction of the substrate, and in a direction away from the second and third antenna elements and towards the first edge 11.

In the illustrative embodiment, the first antenna arms 211, 212 each comprises a first part 211a, 212a connected to the first feed line 210, and extending in two essentially opposite directions. The first parts here extend generally in a width direction of the substrate, and preferably together cover essentially the entire width of the substrate.

The first antenna arms 211, 212 may further each comprise a second part 211b, 212b, connected to the first part 211a, 212a at a distance from the first feed line 210. The second parts 211b, 212b here extend generally in a direction away from the feed 31. The second parts 211b, 212b may extend generally in the length direction of the substrate, and preferably be positioned along the long sides of the substrate.

One of the second parts 212b further comprises a third part 212c, extending from the end of the second 212b part not connected to the first part 211b, and preferably extending generally in the width direction of the substrate. The third part 212c may extend generally along the first edge 11 or short side of the substrate. The third part 212c preferably extends towards the other second part 211b.

The third part 212c may, at the end not connected to the second part 212b, be connected to a fourth part 212d. The fourth part 212d may extend generally in the length direction of the substrate, and in a direction towards the feed 31, and towards the first parts 211a, 212a. The fourth part 212d may e.g. be essentially parallel to the second parts 211b, 212b.

As discussed in the foregoing, a non-conductive zone 25 is provided between the arms and the intermediate element 24. Further, an additional non-conductive areas 25′ may be provided between the arm and arm parts. In this way, one of the arms of the bifurcation may comprise first and second parts 211a, 211b arranged generally in an L-shape, and directed away from the feed. The second part 211b ends in a free end 211b′. The other arm may have first and second parts 212a, 212b arranged generally in an L-shape, and in addition a third part 212c directed towards the other arm, and a fourth part 212d directed towards the feed, to form a curled shape.

The arms preferably have a width which is at all places greater than the width of the first feed line. In an embodiment, at least one of the arms has a terminating, final part having a width which is greater than the width of the other parts of the arm. Thus, in the arm having an L-shape, the second part 211b may have a greater width than the first part 211a. In the arm having a curled shape, the fourth part 212d may have a greater width than the other arm parts 212a-c.

The two arms connected to the first feed line, at the bifurcation, may together form the shape of a fork, with arm parts 211b, 212b extending along the long sides of the substrate, and with the interior of the fork optionally being partly filled with the inwardly curved terminating part of one of the arms.

The L-shaped first arm 211 may further have a part 211e extending in an opposite direction, away from the first edge 11. This additional part 211e preferably has a much smaller extension than the second part 211b directed towards the first edge 11.

Close to the transition between the first part 211a and the second part 211b of the first arm, a small step 211f in the first part 211a, in a direction towards the feed 31, may be provided.

In the vicinity of the feed 31, connection areas or pads 31″ may be provided. The connection areas may be arranged on both sides of small gaps, either in the feed line 210 or between the feed line 210 and the intermediate element 24. The connection areas may be used to connect the feed connector 31′, and also impedance matching components 31a-c, such as resistors, capacitors and inductors.

The third antenna element preferably comprises a third feed line 230 extending between the third antenna feed 33 and a connection position and a generally T-shaped part, wherein a free end, i.e. the base, of a shaft 231 of the T-shaped part is connected to said third feed line 230, and wherein the other end of the shaft 231 is connected to an overlying beam, the beam having two arms 233, 234 connected to the shaft 231 and extending in essentially opposite directions. One arm 234 of the beam is preferably connected to the intermediate element 24, through a connection 235. The other arm 233 forms a free end 233′. Additionally, the beam may be displaced in relation to the shaft, with one beam arm extending farther from the shaft than the other beam arm. In the illustrative example, the arm 233 directed towards the first edge has a substantially longer extension than the arm 234 directed towards the second edge 12.

The third antenna element may be arranged at an intermediate position along the length of the substrate, between the first and second antenna elements, and preferably closer to the second antenna element than to the first antenna element.

The third feed line 230 may be directed generally in a width direction of the substrate. However, alternatively, the third feed line may have a slanted disposition, and be directed both in a width and length direction of the substrate. The third feed line may e.g. be directed generally in a width direction, towards a long side of the substrate, but be inclined towards the second antenna element and the second edge, i.e. in a direction away from the first antenna element and the first edge, when seen from the third feed. In the illustrative example, the feed line 230 comprises a first part, closest to the feed 33, having a slanted disposition, directed both towards long side of the substrate and towards the second edge 12. The slanted part is followed by a second part, generally extending in the width direction of the substrate, which is connected to the shaft 231.

The T-shaped part of the third antenna may have a greater width than the feed line.

The free end of the T-shaped part, forming the bottom of the T, may be connected to the third feed line 230. The shaft 231 of the Tis preferably much shorter than the length of the beam 233, 234. In one embodiment, the beam has a length of at least 2 times the length of the shaft, and preferably at least 3 times, and most preferably about 4 times the length of the shaft.

In one embodiment, the shaft 231 is directed generally in the width direction of the substrate. In one embodiment, the beam 233, 234 is directed generally in the length direction of the substrate.

In one embodiment, one arm 234 of the beam is connected to the intermediate element 24. Preferably, the arm 234 connected to the intermediate element 24 is the one directed towards the second antenna element, and away from the first antenna element 21, as seen from the shaft 231.

In one embodiment, at least one of the two arms forms a free end 233′. Preferably, at least the arm 233 directed towards the first antenna element 21 forms a free end. The free end is preferably surrounded by a non-conductive area 25″.

In one embodiment, the beam is displaced in relation to the shaft, with one beam arm 233 extending farther from the shaft 231 than the other beam arm 234. For example, the arm 233 directed towards the first antenna element 21 may be longer than the arm 234 directed towards the second antenna element 22. The arm 233 with the longer extension may e.g. be at least 2, and preferably at least 3, and more preferably at least 5 times longer than the shorter arm 234. Preferably, the arm 233 forming a free end 233′ is longer than the arm 234 forming a connection to the intermediate element 24.

In the vicinity of the feed 33, connection areas or pads 33″ may be provided. The connection areas may be arranged on both sides of small gaps, either in the feed line 230 or between the feed line 230 and the intermediate element 24. The connection areas may be used to connect the feed connector 33′, and also impedance matching components 33a-c, such as resistors, capacitors and inductors.

The second antenna element 22 preferably comprises a second feed line 220 extending between the second feed 32 and a connection position, connecting the feed line 220 to an end part, wherein the junction between the second feed line 220 and the end part forms an angle, and preferably an essentially right angle. Preferably, the end part is generally U-shaped, with one of the ends being connected to the second feed line. Additionally, or alternatively, the second antenna element may be connected to the intermediate element through a connection 221 at said junction between said second feed line and said end part.

In one embodiment, the second feed line 220 extends essentially in the length direction of the substrate. Preferably, the second feed line 220 extends in a direction, seen from the second feed 32, which is directed away from the first antenna element 21. Preferably, the second feed line 220, extends in a direction which is opposite to the direction of the first feed line 210, as seen from the second and first feeds 31, 32, respectively.

Preferably, the end part is generally U-shaped, with one of the ends, i.e. one of the upper free ends of the U, being connected to the second feed line.

In an embodiment, the end part comprises a first arm section 222, connected to the second feed line 220, and preferably extending in a width direction of the substrate. The end part may further comprise a second arm section 223, forming an angle in relation to the first arm section 222, and preferably essentially a right angle. The second arm section 223 preferably extends along the length direction of the substrate, and preferably in a direction away from the first antenna element 21, as seen from the first arm section 222, i.e. towards the second edge 12. The end part may further comprise a third arm section 224, connected to the second arm section 223 and forming an angle in relation to this, and preferably essentially a right angle. The third arm section 224 preferably extends essentially in the width direction of the substrate, and preferably essentially in parallel with the first arm section 222. The third arm 224 section may extend along the second edge 12 of the substrate. The third arm section 224 preferably forms a free end 224′, not conductively connected to the intermediate element 24.

In the vicinity of the feed 32, connection areas or pads 32″ may be provided. The connection areas may be arranged on both sides of small gaps, either in the feed line 220 or between the feed line 220 and the intermediate element 24. The connection areas may be used to connect the feed connector 32′, and also impedance matching components 32a-c, such as resistors, capacitors and inductors.

The total area of the intermediate layer 24 is preferably significantly greater than the total area of the antenna elements 21, 22, 23. In one embodiment, the total area of the intermediate element is at least 2 times the total area of the antenna elements, and preferably at least 3 times, and more preferably at least 5 times the total area of the antenna elements.

The person skilled in the art realizes that the present invention by no means is limited to the preferred embodiments described above. On the contrary, many modifications and variations are possible within the scope of the appended claims. For example, even though the antenna pattern illustrated in the drawings, and as discussed in the foregoing, have been found to have surprisingly advantageous properties, some deviations from this pattern could be contemplated, and still provide an antenna with adequate properties and performance. For example, the dimensions of various parts could be slightly varied, and some parts of the antenna elements could possibly be omitted or be modified in shape. Further, the antenna arrangement may comprise additional stacked layers, but could also have fewer stacked layers. Further, the antenna arrangement may be provided as a stand-alone unit, but could also be integrated with other structures, such as being formed on a part of a larger substrate used also for other purposes. Such a larger substrate may then also contain additional conductive/wire structure and/or components, such as a transmitter/receiver for the antenna, a battery, a display, signal processing circuits, a processor, etc. These and other related alternatives of the invention shall be regarded as falling within the scope of protection defined in the appended claims.

1.-15. (canceled)

16. An antenna arrangement comprising:
a dielectric substrate with a first surface and second surface extending between a first edge and second edge of the substrate;
a conductive pattern arranged on the first surface of said substrate, the pattern forming:
a first antenna element arranged in the vicinity of the first edge, connected to a first antenna feed;
a second antenna element arranged in the vicinity of the second edge, connected to a second antenna feed;
a third antenna element arranged between the first and second antenna elements, connected to a third antenna feed;
an intermediate element, at least partly functioning as a ground layer, arranged between said first, second and third antenna elements; and
a non-conductive zone separating the first antenna element and the intermediate element;
wherein the second antenna element and the intermediate element are in conductive contact with each other.

17. The antenna arrangement of claim 16, wherein the third antenna element is arranged closer to the second antenna element than to the first antenna element.

18. The antenna arrangement of claim 16, wherein the first antenna element is arranged for radio communication over at least one of a 3G, 4G, 5G and LTE standard.

19. The antenna arrangement of claim 16, wherein the second antenna element is arranged for GNSS radio communication.

20. The antenna arrangement of claim 16, wherein the third antenna element is arranged for communication over at least one of an IEEE 802.11 and Bluetooth standard.

21. The antenna arrangement of claim 16, wherein the first antenna element comprises a first feed line extending between the first antenna feed and a bifurcation and two first antenna arms extending from said bifurcation in at least partly different directions.

22. The antenna arrangement of claim 21, wherein one of said first antenna arms extends generally in an L-shape.

23. The antenna arrangement of claim 21, wherein one of said first antenna arms extends generally in a curled shape.

24. The antenna arrangement of claim 16, wherein the third antenna element comprises a third feed line extending between the third antenna feed and a connection position and a generally T-shaped part, wherein a free end of a shaft of the T-shaped part is connected to said third feed line, and wherein the other end of the shaft is connected to an overlying beam, the beam having two arms connected to the shaft and extending in essentially opposite directions.

25. The antenna arrangement of claim 24, wherein one arm of the beam is connected to the intermediate element, whereas the other arm forms a free end.

26. The antenna arrangement of claim 24, wherein the beam is displaced in relation to the shaft, with one beam arm extending farther from the shaft than the other beam arm.

27. The antenna arrangement of claim 16, wherein the second antenna element comprises a second feed line extending between the second feed and a connection position and an end part, wherein the junction between the second feed line and the end part forms an angle, and preferably an essentially right angle.

28. The antenna arrangement of claim 27, wherein the end part is generally U-shaped, with one of the ends being connected to the second feed line.

29. The antenna arrangement of claim 27, wherein the second antenna element is further connected to the intermediate part at said junction between said second feed line and said end part.

30. The antenna arrangement of claim 16, wherein the first, second and third antenna feeds are all arranged on a common straight line.
